(19) United States
(12) Patent Application Publication
(10) Pub. No.: US 2010/0134859 A1
(43) Pub. Date: Jun. 3, 2010

(54) METHOD AND APPARATUS FOR CONSTRUCTION OF MODULAR GALVANO MOTOR SCANNING HEADS

(76) Inventor: Stephen Hastings, Munchen (DE)

Correspondence Address: FRASER CLEMENS MARTIN & MILLER LLC, 28366 KENSINGTON LANE, PERRYSBURG, OH, 43551, US

(21) Appl. No.: 11/914,985

(22) PCT Filed: Aug. 6, 2007
(86) PCT No.: PCT/EP2007/058148

§ 371 Date: Nov. 20, 2007

(51) Int. Cl. G02B 26/10; B23P 11/00

(52) U.S. Cl. 359/200.7; 29/428

(57) ABSTRACT

This invention relates to an apparatus of galvano motor scanning head modular construction, assembly and calibration. In addition, the invention relates to the apparatus and construction method to achieve modular galvano motor scanning head products whereby multiple galvano motor and/or multiple galvano motor driven scanning mirror substrates and/or multiple beam expansion or beam collimation or beam de-collimation input optics and/or multiple output delivery optics and/or multiple galvano motor drive electronics configurations may be used to produce said modular galvano motor scanning head dependent upon customer required configurations.

### FIELD OF THE INVENTION

This invention relates to an apparatus of galvano motor scanning head modular construction, assembly and calibration. In addition, the invention relates to the apparatus and construction method to achieve modular galvano motor scanning head products whereby multiple galvano motor and/or multiple galvano motor driven scanning mirror substrates and/or multiple beam expansion or beam collimation or beam de-collimation input optics and/or multiple output delivery optics and/or multiple galvano motor drive electronics configurations may be used to produce said modular galvano motor scanning head dependent upon customer required configurations.

### BACKGROUND OF THE INVENTION

Traditional galvano motor scanning head construction is limited by several factors:

Firstly, and because galvano motor driven scanning mirrors are commonly wider than the diameter of the galvano motor body, each galvano motor driven scanning mirror must be attached to the galvano motor rotating spindle either directly or by use of an intermediate mount after said galvano motor has been passed through an aperture commonly narrower than said galvano motor driven scanning mirror and said galvano motor is then fixed in position by restriction of said aperture, said galvano motor scanning mirrors are commonly bulk tuned meaning that one mounted mirror of each axis used is tuned using the respective galvano motor drive electronics to eliminate resonance effects and then presumed that all identical mounted mirrors of each axis will be identically balanced and have the exact same resonance or resonances to be filtered by a single tuning set-up of said galvano motor drive electronics.

Secondly, because said galvano motor driven scanning mirrors are commonly wider than the diameter of said respective galvano motor bodies, in a production environment each galvano motor driven scanning mirror must he attached to the galvano motor rotating spindle either directly or by use of an intermediate mount after said galvano motor has been positioned and before clamping though restriction of said aperture of a galvano motor mount.

Third, because said galvano motor driven scanning mirror or mirrors is/are attached to said galvano motor rotating spindle or said galvano motor rotating spindles either directly or by use of an intermediate mount or mounts after said galvano motor or galvano motors has/have been positioned and before clamping though the restriction of said aperture of a galvano motor mount or mounts, the process of positional alignment and adjustment of said galvano motor drive electronics must be set for both gain and offset for the complete set of and commonly two axes after said complete set of and commonly two axes are mounted within the aforementioned galvano motor mount or galvano motor mounts.

Fourth, because said process of positional alignment and adjustment of said galvano motor drive electronics must be set for both gain and offset for the complete set of and commonly two axes after said complete set of and commonly two axes are mounted within the aforementioned galvano motor mount or galvano motor mounts it is a more difficult, time-consuming and complicated calibration where operator error can mean that either or a combination of inappropriate gain and offset settings of the galvano drive electronics may cause said galvano motor driven scanning mirrors to meet and often if so meeting with catastrophic consequences.

Fifth, because said galvano motor mount or galvano motor mounts are machined to a specific bore diameter to accommodate said galvano motors, if any other galvano motor at any other diameter is required to be used with differing capabilities such as performance, repeatability, accuracy and/or price, said galvano motor mount or galvano motor mounts must be changed to a different galvano motor mount or differing galvano motor mounts to accommodate any difference in galvano motor body diameters.

### SUMMARY OF THE INVENTION

A method is provided for the mounting of a galvano motor or galvano motors using a casing or casings, said individual casing having a fixed outer diameter corresponding to a general galvano motor bore way centred along the axis of rotation of said galvano motor, and in the example embodiment being manufactured from two parts.

The inside diameter of said casing split in the example embodiment into two parts with a small gap either side to allow compression and fixing of said galvano motor and having an internal diameter the same diameter as a corresponding galvano motor body or a larger diameter than said corresponding galvano motor body allowing said compression of the two halves of the casing in the example embodiment with a fixing or fixings to fix the galvano motor and the two halves of the casing of the example embodiment in position.

In this method a scanblock is designed, set and manufactured only by optical beam aperture where said optical beam may be a beam of laser energy, and where only the replacement of the two halves of the casing in the example embodiment are required to be changed in order to change the type of galvano motor used.

The method comprises a scanblock set only by the beam aperture into which is manufactured a beam entry path, a scan chamber, the bore ways to accommodate the galvano motors held in said casings, galvano motor driven scanning mirror or mirrors and if required intermediate mount or mounts to attach said galvano motor driven scanning mirror or mirrors to said galvano motor rotating spindle or spindles and retaining fixings to fix said galvano motors held in said casings, galvano motor driven scanning mirror or mirrors and if required intermediate mount or mounts to attach said galvano motor driven scanning mirror or mirrors to said galvano motor rotating spindle or spindles.

Additionally, there is also provided engineering to accommodate a beam entry path optic or beam entry path optics so that the final optic on the beam entry path may seal the aforementioned scan chamber from the external atmosphere. Said optics may be of a variety of optically transmissive materials depending upon the wavelength used and to expand, collimate or focus a beam through the assembly and ideally having a common output element of common output elements per wavelength or suitable combination of wavelengths.

Additionally, there is also provided engineering to accommodate a beam exit path optic or beam exit path optics so that the first optic on the beam exit path may also seal the aforementioned scan chamber from the external atmosphere and together with the final optic on the beam entry path provide the scan chamber with an internal atmosphere isolated from the external atmosphere. Said optics may be of a variety of optically transmissive materials depending upon the wavelength used and to expand, collimate or focus a beam through the assembly and ideally having a common input element of common input elements per wavelength or suitable combination of wavelengths.

Additionally, there is also provided a pre-determined index mark or point for rotational positional alignment of a first axis beam steering or galvano driven scanning mirror attached either directly or using an intermediate mount to a galvano motor using an alignment beam located to enter the scan head or scanning head or scan block on the beam entry axis and deflecting off said beam steering or galvano driven scanning mirror.

Additionally, there is also provided a beam exit path tool with a pre-determined index mark or point for rotational positional alignment of a second axis beam steering or galvano driven scanning mirror attached either directly or using an intermediate mount to a galvano motor using an alignment beam located to enter the scan head or scanning head or scan block on the beam entry axis and deflecting off a first calibrated beam steering or galvano driven scanning mirror onto said second beam steering or galvano driven scanning mirror.

### BRIEF DESCRIPTION OF THE DRAWINGS

FIG. 1 is an isometric diagram depicting an ideal layout of the components required to fix a single galvano motor into position using casings.

FIG. 2 is a simple single elevation cross-sectional diagram depicting a single fixing location through a scan block to fix a single galvano motor using casings and highlighting how the galvano motor may he positionally indexed to said casings and how the casings may be positionally indexed to the scan block.

FIG. 3 is a simple diagram depicting a single fixing location through a scan block to fix a single galvano motor in a pair of casing halves.

FIG. 4 is an isometric diagram depicting an ideal layout of a two-axis scan block showing two galvano motors in position and two respective fixing locations through a scan block to fix the said two galvano motors into said scan block.

FIG. 5 is an isometric diagram depicting an ideal layout of a two-axis scan block from the underside showing how two galvano motors and their respective galvano motor driven scanning mirrors are positioned within the scan chamber, and also depicting an entry optic on the beam entry path.

### DETAILED DESCRIPTION OF THE INVENTION

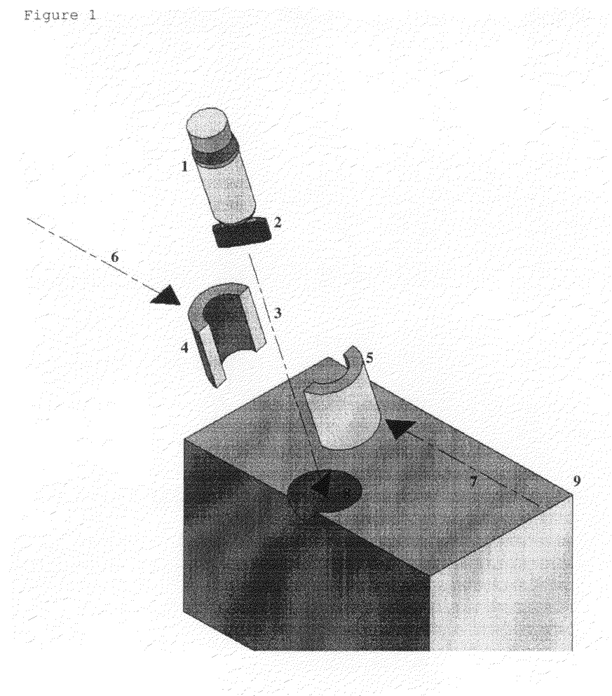

As depicted in FIG. 1, a galvano motor (1) comprising a motor body (21, not shown) of a specific diameter and a position detector body (22, not shown) of another diameter is required to be accurately positioned along an axis (3) in respect to a beam path and commonly a laser beam path so that a beam steering or galvano driven scanning mirror (2) attached to said galvano motor (1) is positioned correctly to intersect said beam path.

Also depicted in FIG. 1 as an example embodiment, two casings (4) and (5) are positioned in the respective directions (6) and (7) around said galvano motor body (21, not shown) without contact to said beam steering or galvano driven scanning mirror (2) so that said galvano motor (1) seats correctly to said casings (4) and (5) by contact of a flange area (23, not shown) between the diameter of the motor body (21, not shown) and the diameter of the position detector body (22, not shown) of said galvano motor (1).

The assembly now comprising galvano motor (1) and casings (4) and (5) may now be positioned along axis (3) and located into an axis bore way (8) within a scan head or scanning head or scan block (9).

A retaining fixing (10) may then be located along a retaining axis (11) and fixed into a retaining axis bore way (12) to apply pressure onto casing (5) compressing against casing (4) and holding said galvano motor (1) in position.

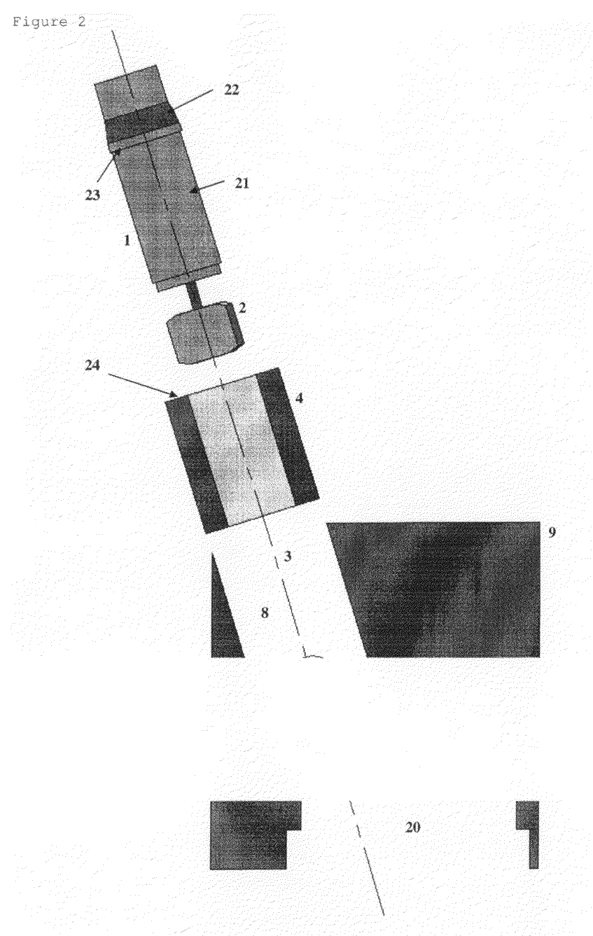

As depicted in FIG. 2, the galvano motor (1) showing the diameter of the motor body (21) and diameter of the position detector body (22) with the beam steering or galvano driven scanning mirror (2) attached to the galvo motor's rotating spindle may in this embodiment be positioned within two casings (4) and (5, not shown) so that the flange (23) of the galvano motor (1) separating the diameter of the motor body (21) and the diameter of the position detector body (22) seats accurately on the top edge (24) of the casings (4) and (5, not shown).

The assembly comprising galvano motor (1) beam steering or galvano driven scanning mirror (2) and casings (4) and (5, not shown) are then positioned along an axis (3) and into a locating bore way (8) to seat accurately within a scan head or scanning head or scan block (9) on an engineered flange (25) and fixed by a fixing (12) so that the beam steering or galvano driven scanning mirror (2) intersects a beam at the correct depth within a scan chamber (20).

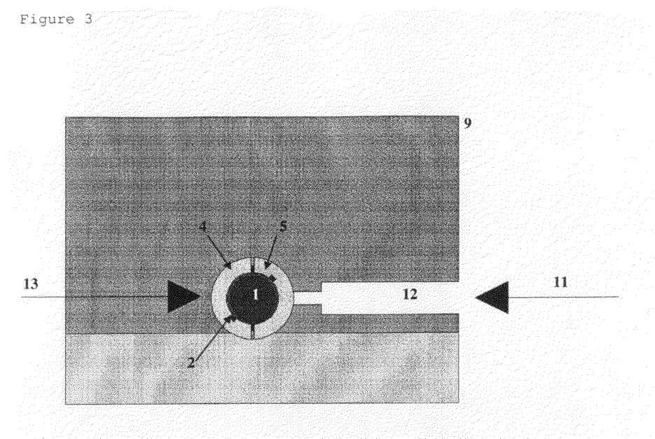

As depicted in FIG. 3, and looking down the axis of a galvano motor bore way in plan, a galvano motor (1) is in this embodiment positioned within two casings (4) and (5) without contact to a beam steering or galvano driven scanning mirror (2) and allowing said beam steering or galvano driven scanning mirror (2) attached to the galvo motor's rotating spindle to be located within a scan chamber (not shown) and fixed in this embodiment by a single fixing positioned along an axis (11) and through a fixing bore way (12) within a scan head or scanning head or scan block (9) so that a beam path and commonly a laser beam path (13) intersects correctly with said beam steering or galvano driven scanning mirror (2) attached to said galvano motor (1).

In this method multiple galvano motor types and galvano motor driven mirror types may be utilised by only changing the casing inside diameters and depths.

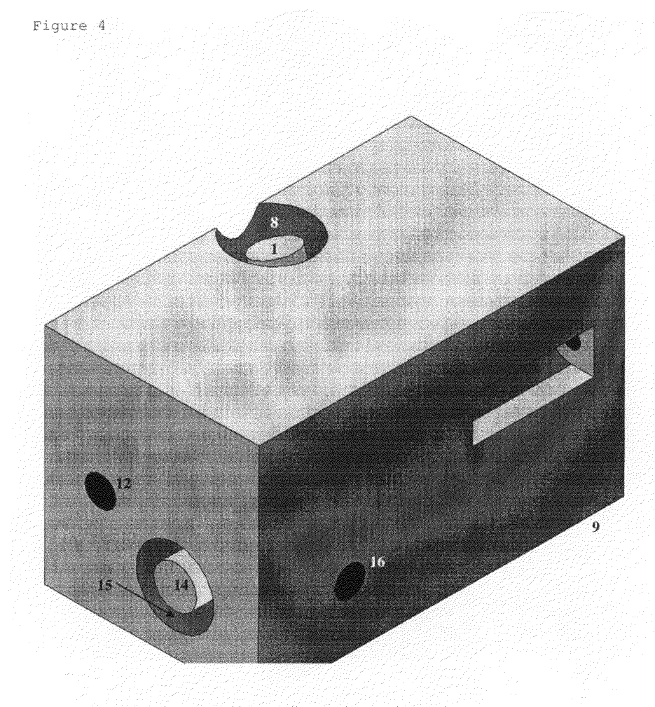

As depicted in FIG. 4, an embodiment of a two axis scan head or scanning head or scan block (9) shows the located positions of a first galvano motor (1) in a first axis bore way (8) fixed by a single fixing within a fixing bore way (12) and a second a galvano motor (14) in a second axis bore way (15) fixed by a single fixing within a fixing bore way (16).

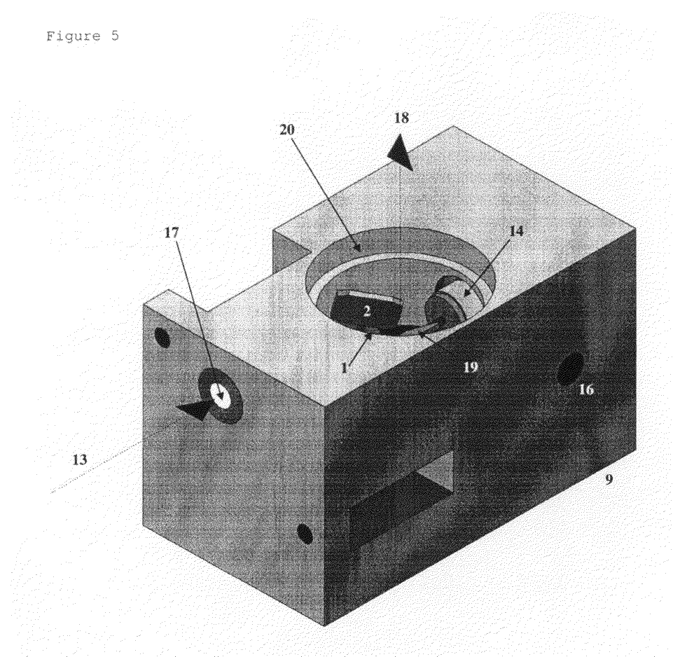

As depicted in FIG. 5, an embodiment of a two axis scan head or scanning head or scan block (9) shows the beam entry path (13) through an input aperture of said scan head or scanning head or scan block (9) and in this embodiment comprising a first beam entry axis optic (17) which may be subsequently expanded, collimated or focused to intersect with a first beam steering or galvano driven scanning mirror (2) attached to a first galvano motor (1) held in this embodiment within two casings (not shown) fixed by a fixing (not shown) and deflected onto a second beam steering or galvano driven scanning mirror (19) attached to a second galvano motor (14) also fixed in this embodiment within two casings (not shown) and fixed by a fixing located in a fixing bore way (16).

Because said scan head or scanning head or scan block (9) may be engineered to accommodate a beam entry bore way for the entry beam to enter said scan head or scanning head or scan block (9) along a beam entry path (13), single or multiple optics may be located and/or fixed with said beam entry bore way to expand, collimate and/or focus said beam without the requirement for additional housings.

Furthermore, adjustors or adjusting mechanisms may be used to change the position of individual elements of said optics in relation to said beam entry path (13) to further calibrate the beam through the apparatus of the scan head or scanning head or scan block (9).

Because said scan head or scanning head or scan block (9) may be engineered to accommodate a beam exit bore way for the exiting beam to exit said scan head or scanning head or scan block (9) along a beam exit path (18) out of a scan chamber (20) containing in this embodiment a first beam steering or galvano driven scanning mirror (2) and a second beam steering or galvano driven scanning mirror (19), single or multiple optics may be located and/or fixed within said beam exit bore way to prepare said beam for targeting without the requirement for additional housings.

Advantageously, in an example embodiment, in production beam steering or galvano driven scanning mirrors would be attached to respective galvano motors and tuned and calibrated with respective drive electronics for resonance and resonance filtering and positional linearity and using a method with an alignment beam reflecting off said beam steering or galvano driven scanning mirrors (2) and (19) onto a pre-calibrated target so that both gain and offset may be set before the galvano motor (1) or (14) and its beam steering or galvano driven scanning mirror (2) or (19) is introduced into the scan head or scanning head or scan block (9).

Said galvano motor (1) is then held between two casings (4) and (5) and is positionally indexed for depth by contact between the flange (23) separating the motor body (21) and position detector body (22) parts of said galvano motor (1) and the galvano motor (1) and casing assembly (4) and (5) positioned through a bore way (8) in said scan head or scanning head or scan block (9) and is positionally indexed for depth in said scan head or scanning head or scan block (9) by contact between a flange or lip (25) in said scan head or scanning head or scan block (9) and said casings (4) and (5).

Said beam steering or galvano driven scanning mirror (2) may subsequently be correctly positioned rotationally perpendicular to the axis of said bore way (8) in said scan head or scanning head or scan block (9) by rotating said galvano motor (1) in said casings (4) and (5) so that an alignment beam deflecting off said beam steering or galvano driven scanning mirror (2) strikes a pre-determined index mark or point.

Said galvano motor (1) and casing assembly (4) and (5) are then ready to be fixed in position with a retaining fixing (10) and a second galvano motor (14) is then held between two additional casings (not shown) and is positionally indexed for depth by contact between the flange separating the motor body and position detector body parts of said second galvano motor (14) and the second galvano motor (14) and second casing assembly (not shown) positioned through a second bore way (15) in said scan head or scanning head or scan block (9) and is positionally indexed for depth in said scan head or scanning head or scan block (9) by contact between a flange or lip engineered at a specific depth within said second bore way (15) in said scan head or scanning head or scan block (9) and said second casings (not shown).

Said second beam steering or galvano driven scanning mirror (19) may subsequently be correctly positioned rotationally perpendicular to the axis of said second bore way (15) in said scan head or scanning head or scan block (9) by rotating said second galvano motor (14) in said second casings (not shown) so that an alignment beam deflecting off said first beam steering or galvano driven scanning mirror (2) strikes and deflects off said second beam steering or galvano driven scanning mirror (19) to a pre-determined index mark or point, and possibly marked or drilled in this embodiment within an output alignment plate (not shown) fixed into a position where normally an exit axis optic or exit axis optics would later be located. Said second galvano motor (14) and second casing assembly (not shown) are then ready to be fixed in position with a second retaining fixing (16).

1. An apparatus of galvano motor scan head or scanning head or scan block modular construction to achieve a modular galvano motor scanning head product whereby multiple galvano motor and multiple galvano motor driven scanning mirror substrates and/or multiple beam expansion or beam collimation or beam de-collimation or beam window input optics and/or multiple delivery optics and/or multiple galvano motor drive electronics may be used to produce said modular galvano motor scanning head dependent upon customer required configurations whereby larger diameter casings are used to clamp around a galvano motor body without contact to or hinderance of a beam steering or galvano driven scanning mirror and are fixed in position by a retaining fixing whereby;
a) said galvano motor locates to its correct depth position in relation to the correct position for said beam steering or galvano driven scanning mirror to intersect a beam path, and
b) said larger diameter casings locate to their correct depth position against a locating flange engineered into said scan head or scanning head or scan block in relation to the correct position for said galvano motor indexed as described in a) above and therefore said beam steering or galvano driven scanning mirror intersects a beam path at the correct depth.

2. The method as claimed in claim 1, wherein a beam entry path optic or beam entry path optics may be located within the beam entry bore way of said motor scan head or scanning head or scan block.

3. The method as claimed in claims 1-2, wherein a beam exit path optic or beam exit path optics may be located within the beam exit bore way of said motor scan head or scanning head or scan block.

4. The method as claimed in claims 1-3, wherein galvano motor drive electronics may be packaged with said scan block.

5. The method as claimed in claims 1-4, wherein more or less than two casings or casing components may be used to locate and hold said galvano motor.

6. The method as claimed in claims 1-5, wherein multiple fixings may be used to secure casings and respective galvano motor.

7. The method as claimed in claims 1-6, wherein said casings may be of any profile design.

8. The method as claimed in claims 1-7, wherein an index point is marked within the scan chamber so that the beam of an alignment laser may be used to deflect off the first beam steering or galvano driven scanning mirror onto said index point to effect rapid calibration of the first axis of the system during assembly.

9. The method as claimed in claims 1-8, wherein an index point is marked on an alignment plate or optic or tool that is then indexed to the scan chamber so that the beam of an alignment laser may be used to deflect off a pre-aligned first beam steering or galvano driven scanning mirror onto the second beam steering or galvano driven scanning mirror and onto said index point to effect rapid calibration of the second axis of the system during assembly.

10. The method as claimed in claims 1-9, wherein all galvano motors are pre-tuned and/or calibrated with beam steering or galvano driven scanning mirrors attached either directly or by use of an intermediate mount for gain, offset and angular position linearity before assembly of the scan head or scanning head or scan block.
